(19) United States
(12) Patent Application Publication
(10) Pub. No.: US 2017/0321109 A1
(43) Pub. Date: Nov. 9, 2017

(54) VISCOELASTIC SURFACTANT COMPATIBLE ACID CORROSION INHIBITOR AND METHODS OF USING SAME

(71) Applicant: BAKER HUGHES, A GE COMPANY, LLC, HOUSTON, TX (US)

(72) Inventors: JINGSHE SONG, SUGAR LAND, TX (US); MICHAEL L. WALKER, SUGAR LAND, TX (US); HAFID J. HERNANDEZ, HOUSTON, TX (US); WILLIAM STEVENS, SUGAR LAND, TX (US)

(73) Assignee: BAKER HUGHES, A GE COMPANY, LLC, HOUSTON, TX (US)

(21) Appl. No.: 15/590,586

(22) Filed: May 9, 2017

Related U.S. Application Data
(60) Provisional application No. 62/333,585, filed on May 9, 2016.

(51) Int. Cl. C09K 8/54; C09K 8/60; C09K 8/74; C09K 8/68; E21B 43/26

(52) U.S. Cl. CPC C09K 8/54; C09K 8/74; C09K 8/68; C09K 8/602; C09K 2208/30; E21B 43/26

(57) ABSTRACT

An acid corrosion inhibitor is provided that is compatible with viscoelastic surfactants and useful for enhancing the production of hydrocarbon bearing formations. The viscoelastic surfactant can used in fracturing of subterranean formations penetrated by an oil or gas well or in connection with acidizing or other treatment processes. The acid corrosion inhibitor can include a viscoelastic surfactant and an active inhibition compound which can comprise a reaction product of thiourea, paraformaldehyde and acetophenone, or amines (linear or cyclic), amine quaternaries (linear or cyclic) or combinations or mixtures thereof.

### RELATED APPLICATIONS

This application claims the benefit, and priority benefit, of U.S. Provisional Patent Application Ser. No. 62/333,858, filed May 9, 2016, the disclosure and contents of which are incorporated by reference herein in their entirety.

### BACKGROUND

### Description of Art

Commercial exploitation of low permeability carbonate reservoirs can be achieved through acidizing and/or fracturing to improve hydrocarbon productivity. Viscoelastic surfactants (VES) have been applied as acid diverting agents in these reservoirs. These viscoelastic surfactants have an advantage over polymeric materials for use as acid diverting agents because of better cleanup and less formation damage.

When viscoelastic surfactants are initially dispersed in acid, each molecule moves independently throughout the fluid. As the acid reacts with the carbonate minerals, the viscoelastic surfactant molecules assemble and create elongated micelles. The micelles entangle and hinder fluid flow, resulting in higher viscosity. When hydrocarbon production begins after the treatment, the elongated micelles transform into spheres, resulting in a dramatic decrease in fluid viscosity and facilitating efficient cleanup.

There are three main types of viscoelastic surfactants that are currently applied as acid diverting agents: cationic based, amine-oxide based and betaine based. These viscoelastic surfactant systems exhibit diminished performance in spent acid when currently available acid corrosion inhibitors (ACIs) are added. When these ACIs are added, the viscoelastic surfactant systems lose high viscosity. These and other limitations of VES technology have prevented the widespread adoption of this technology in the field.

Improvements in this field of technology are therefore desired

### SUMMARY

Various illustrative embodiments of an acid corrosion inhibitor for use with a viscoelastic surfactant fluid are provided. In certain aspects, the acid corrosion inhibitor can include an active inhibition compound and a viscoelastic surfactant. In certain illustrative embodiments, a dispersing surfactant can comprise the viscoelastic surfactant and a dispersing agent which is compatible with the viscoelastic surfactant. The active inhibition compound can include a reaction product of thiourea, paraformaldehyde and acetophenone, or amines (linear or cyclic), amine quaternaries (linear or cyclic) or combinations or mixtures thereof. The viscoelastic surfactant can include a betaine-based surfactant. The viscoelastic surfactant can also include an amine oxide-based surfactant and/or a cationic surfactant, or mixtures thereof. The active inhibition compound can include an inhibition compound that is effective in acidizing fluids. The acid corrosion inhibitor can further include an organic acid. The organic acid can be acetic acid. The organic acid can be formic acid.

Various illustrative embodiments of a viscoelastic surfactant fluid for enhancing the productivity of a hydrocarbon bearing subterranean formation are also provided. In certain aspects, the viscoelastic surfactant fluid can include an acid corrosion inhibitor, wherein the acid corrosion inhibitor includes an active inhibition compound and a compatible viscoelastic surfactant. The acid corrosion inhibitor can further include an organic acid. The viscoelastic surfactant can further include a betaine-based surfactant. The viscoelastic surfactant can include erucamidopropyl hydroxypropylsultaine. The viscoelastic surfactant can include an amine oxide-based surfactant. The viscoelastic surfactant can include a cationic surfactant. The active inhibition compound can include a reaction product of thiourea, paraformaldehyde and acetophenone, or amines (linear or cyclic), amine quaternaries (linear or cyclic) or combinations or mixtures thereof. The active inhibition compound can include an inhibition compound that is effective in acidizing fluids.

Various illustrative embodiments of a method of treating a hydrocarbon bearing subterranean formation are also provided. In certain aspects, a treatment fluid can be introduced into the subterranean formation. The treatment fluid can include a viscoelastic surfactant fluid and an acid corrosion inhibitor that is compatible with the viscoelastic surfactant fluid. The acid corrosion inhibitor can include an acid, an erucamidopropyl hydroxypropylsultaine, and a reaction product of thiourea, paraformaldehyde and acetophenone, or amines (linear or cyclic), amine quaternaries (linear or cyclic) or combinations or mixtures thereof. The subterranean formation can be treated with the treatment fluid. The hydrocarbon bearing subterranean formation can be subjected to fracturing during treatment with the treatment fluid. The hydrocarbon bearing subterranean formation can also be subjected to acidizing during treatment with the treatment fluid.

### BRIEF DESCRIPTION OF THE DRAWINGS

FIG. 1 is a graph comparing viscosity and temperature over time for 5% EHS or 6% APA-TW in 30% CaCl₂.

FIG. 2 is a graph comparing viscosity and temperature over time for 5% EHS in 30% CaCl₂ with pH adjusted to 3.7 with HCl solution.

FIG. 3 is a graph comparing viscosity and temperature over time and comparing the effects of 1% ACI CI-1 on 5% EHS in 30% CaCl₂ (pH<1.70).

FIG. 4 is a graph comparing viscosity and temperature over time and comparing the effects of 1% ACI CI-1 on 5% EHS in 30% CaCl₂ (pH adjusted to 3.3).

FIG. 5 is a graph comparing viscosity and temperature over time and comparing the effects of 2% ACI CI-2 on 5% EHS in 30% CaCl_{2.}

FIG. 6 is a set of graphs comparing viscosity and temperature over time and comparing the effects of 0.5% new ACI on 5% EHS in 30% CaCl₂ (pH adjusted to 3.1, top graph without ACI, middle graph with ACI IC-1 and lower graph with IC-2) according to certain illustrative embodiments.

FIG. 7 is a set of graphs comparing viscosity and temperature over time and comparing the effects of new ACIs on 5% EHS in 30% CaCl₂ (pH adjusted to 3.1, top graph without ACI, middle graph with 1.2% ACI IC-1 and lower graph with 1.5% IC-2) according to certain illustrative embodiments.

FIG. 8 is a graph comparing viscosity and temperature over time and comparing various viscoelastic surfactant fluids designed for 190° F. corrosion inhibition in 15% HCl according to certain illustrative embodiments.

FIG. 9 is a graph comparing viscosity and temperature over time for a viscoelastic surfactant fluid designed for 190° F. corrosion inhibition in 28% HCl according to certain illustrative embodiments.

FIG. 10 is a graph comparing viscosity and temperature over time and comparing various viscoelastic surfactant fluids designed for 275° F. corrosion inhibition in 15% HCl according to certain illustrative embodiments.

FIG. 11 is a graph comparing viscosity and temperature over time for a viscoelastic surfactant fluid designed for 275° F. corrosion inhibition in 28% HCl according to certain illustrative embodiments.

FIGS. 12-13 are graphs showing the viscosity of live acids at ambient temperature according to certain illustrative embodiments.

FIG. 14 is a graph showing breaking tests of various ACI fluids with EGMBE @190° F. in 15% spent HCl according to certain illustrative embodiments.

FIG. 15 is a graph showing breaking tests of various ACI fluids with Hexane @190° F. in 15% spent HCl according to certain illustrative embodiments.

While certain preferred illustrative embodiments will be described herein, it will be understood that this description is not intended to limit the subject matter to those embodiments. On the contrary, it is intended to cover all alternatives, modifications, and equivalents, as may be comprised within the spirit and scope of the subject matter as defined by the appended claims.

### DETAILED DESCRIPTION

The presently disclosed subject matter relates to a viscoelastic surfactant compatible acid corrosion inhibitor and methods of using same.

In certain illustrative embodiments, an acid corrosion inhibitor is provided that is compatible with viscoelastic surfactants and useful for enhancing the production of hydrocarbon bearing formations. For example, the viscoelastic surfactant can used in fracturing of subterranean formations penetrated by an oil or gas well or in connection with acidizing or other treatment processes.

In certain illustrative embodiments, the acid corrosion inhibitor can include a viscoelastic surfactant and an active inhibition compound which can comprise a reaction product of thiourea, paraformaldehyde and acetophenone, or amines (linear or cyclic), amine quaternaries (linear or cyclic) or combinations or mixtures thereof. The ACI can also include an organic acid. The acid corrosion inhibitor can also include additional acids such as acetic acid, formic acid, or mixtures of the aforementioned acids.

Examples of viscoelastic surfactants that may be utilized in preparing the acid corrosion inhibitor according to the presently disclosed subject matter can include, but are not limited to, erucamidopropyl hydroxypropyl sulfobetaine, erucamidopropyl hydroxyethyl sulfobetaine, erucamidopropyl hydroxymethyl sulfobetaine, and combinations and mixtures thereof. Armovis® EHS, an erucamidopropyl hydroxypropylsultaine, that is commercially available from AkzoNobel of Chicago, Ill., can also be utilized. The aforementioned viscoelastic surfactants are described in U.S. Patent Publication No. 2014/0076572 published Mar. 20, 2014, and U.S. Patent Publication No. 2014/0076572 published Jan. 21, 2016, each assigned to AkzoNobel, the contents of each of which are incorporated by reference herein in their entireties.

In certain illustrative embodiments, Armovis® EHS is the dispersant used to dissolve the reaction product of thiourea, paraformaldehyde and acetophenone into the medium. The preparation of the acid corrosion inhibitor using the reaction product of thiourea, paraformaldehyde and acetophenone is explained in further detail as follows: thiourea-formaldehyde-acetophenone polymer was synthesized by polycondensation of thiourea, a formaldehyde source and acetophenone in an acidic medium at 200 to 250° F. Fatty acid or EHS was added to dissolve the raw materials and the resulting polymer. After the reaction was complete and cooled to 140° F., formic acid or acetic acid was added to make a homogeneous solution.

In certain illustrative embodiments, a viscoelastic surfactant fluid is provided. The viscoelastic surfactant fluid can enhance the productivity of a hydrocarbon bearing subterranean formation. The viscoelastic surfactant fluid can include the acid corrosion inhibitor described herein. The viscoelastic surfactant fluid can also include a viscoelastic surfactant such as Armovis® EHS. That is, a first amount of viscoelastic surfactant is used to prepare the acid corrosion inhibitor, and a second amount of viscoelastic surfactant is used in the viscoelastic surfactant fluid along with the acid corrosion inhibitor, which contributes to the addition of EHS-containing corrosion inhibitor increasing the viscosity of the fluids.

In certain illustrative embodiments, a method of treating a hydrocarbon bearing subterranean formation is provided. A treatment fluid can be introduced into the subterranean formation. The treatment fluid can include the viscoelastic surfactant fluid described herein. The subterranean formation can be treated with the treatment fluid. In certain illustrative embodiments, the hydrocarbon bearing subterranean formation can be subjected to fracturing and/or acidizing during treatment with the treatment fluid. For example, a producing zone of the hydrocarbon bearing subterranean formation can be stimulated by introducing the treatment fluid into the producing zone to dissolve materials which might impede well productivity, and thereby increase its porosity and permeability.

In certain illustrative embodiments, the acid corrosion inhibitor utilizes a viscoelastic surfactant as the dispersant and has a minimal amount solvent in the formulation. For example, the viscoelastic surfactants can be Armovis® EHS (or “EHS-VES”), which is commercially available from AkzoNobel Surface Chemistry. Armovis® EHS is a type of tallow-based betaine. The solvent can be, for example, formic acid, and can be utilized in an amount ranging from about 10% to 90%.

In certain illustrative embodiments, the acid corrosion inhibitor can maintain or improve the performance of the viscoelastic surfactant in spent acid. The acid corrosion inhibitor can also provide corrosion protection and maintain a high viscoelasticity for the viscoelastic surfactant fluids at high temperatures. For example, the acid corrosion inhibitor can also provide acid corrosion inhibition in HCl up to 28% at up to 300° F. The acid corrosion inhibitor can also provide enhance the performance of viscoelastic surfactant fluids at 200° F. or below.

To facilitate a better understanding of the presently disclosed subject matter, the following examples of certain aspects of certain embodiments are given, as compared to prior art systems. In no way should the following examples be read to limit, or define, the scope of the presently disclosed subject matter.

Experimental Testing for Prior Systems

High temperature and high pressure rheometer testing was performed for viscoelastic surfactants (VESs) with different existing acid corrosion inhibitors (ACIs) in spent acids. These experiments were designed to test whether the components in these existing ACIs interfered with the viscoelasticity of the VES fluids at temperatures up to 350° F.

There are two major types of ACIs that are currently used for VES fluids. One is polymer-based and the other is a simple blending of small molecules. The polymer-based ACI is more effective than the simple blends because the components in simple blends sometimes break the viscoelasticity of VES fluids while the polymer has minimal impact. Polymer-based ACIs also have a better environmental profile due to lower toxicity.

ACI polymers are not soluble or dispersible in acid, so ACI polymers must be formulated into mutual solvents, organic acids, non-ionic surfactants or other dispersants. However, the test results showed that solvents, dispersants, organic acids and organic alcohols that were tested for use in ACIs had negative effects on the performance of the VES fluids.

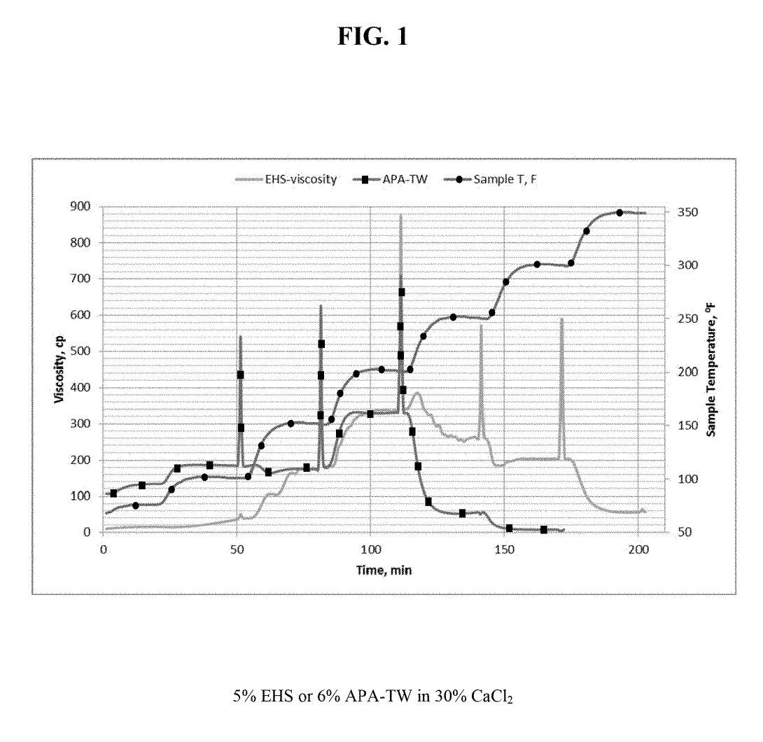

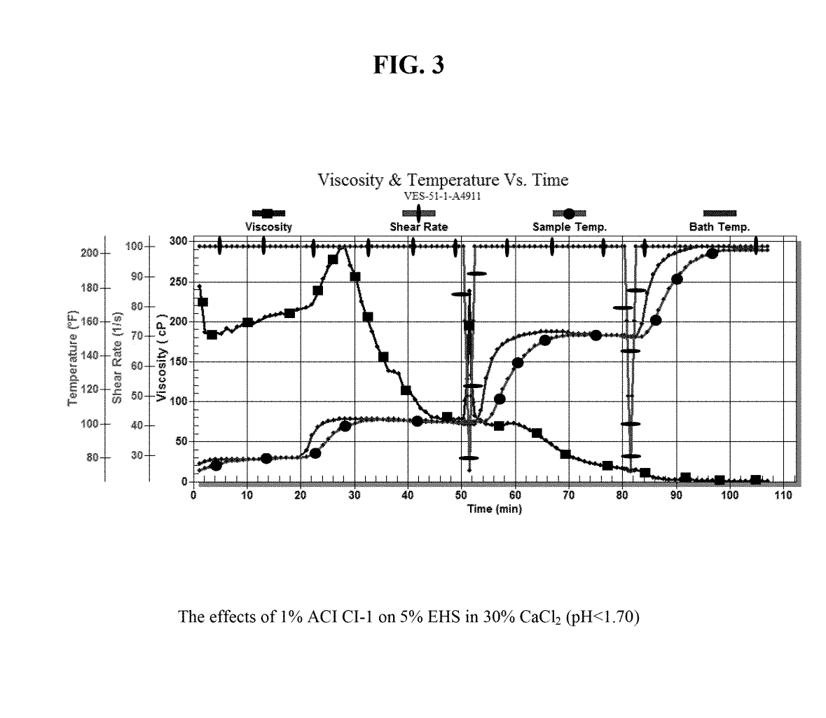

5% Armovis® EHS and 6% APA-TW (amine oxide based VES) in 30% CaCl₂ were tested at various temperatures. The results are shown in FIGS. 1-5. 5% EHS gave high viscosity up to 350° F. while 6% APA-TW only gave high viscosity up to 250° F. (see FIG. 1). When the acid corrosion inhibitors 1% CI-1 and 2% CI-2 were added to 5% EHS and 6% APA-TW solutions in 30% CaCl₂, the high viscosity of these fluids was quickly lost at increased temperature (see FIGS. 3-5). One reason for this loss might be the interaction of ACI CI-1 with Armovis® EHS. Another reason could be the pH change because CI-1 was dispersed in acetic acid, which decreased the pH of the fracturing fluids and high viscosity was lost at low pH.

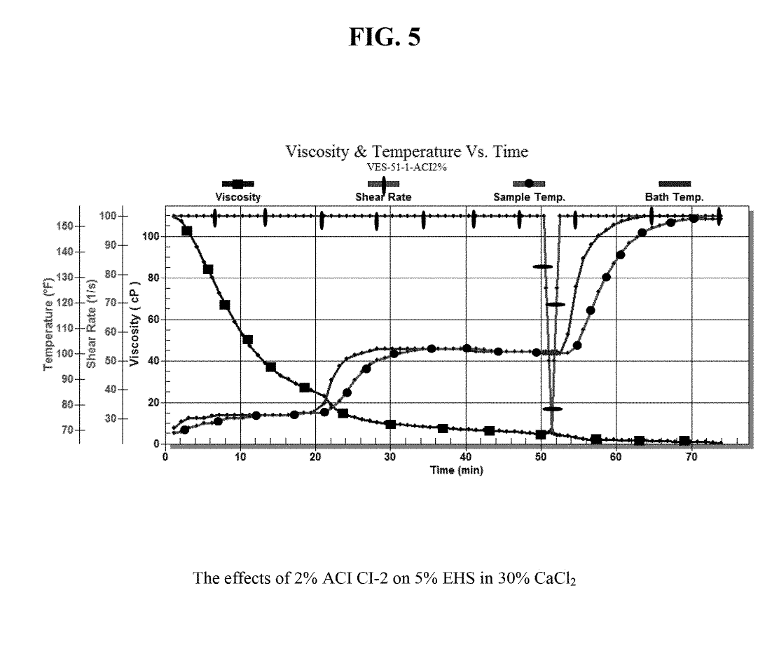

Commercial inhibitor CI-1 is a polymer-based ACI which is a reaction product of thiourea, paraformaldehyde and acetophenone dispersed in fatty acid, or acetic acid. Commercial inhibitor CI-2 is a simple blend of small molecules (acetophenone, cinnamic aldehyde, and acetic acid) which destroyed the viscosity at increased temperature (see FIG. 5).

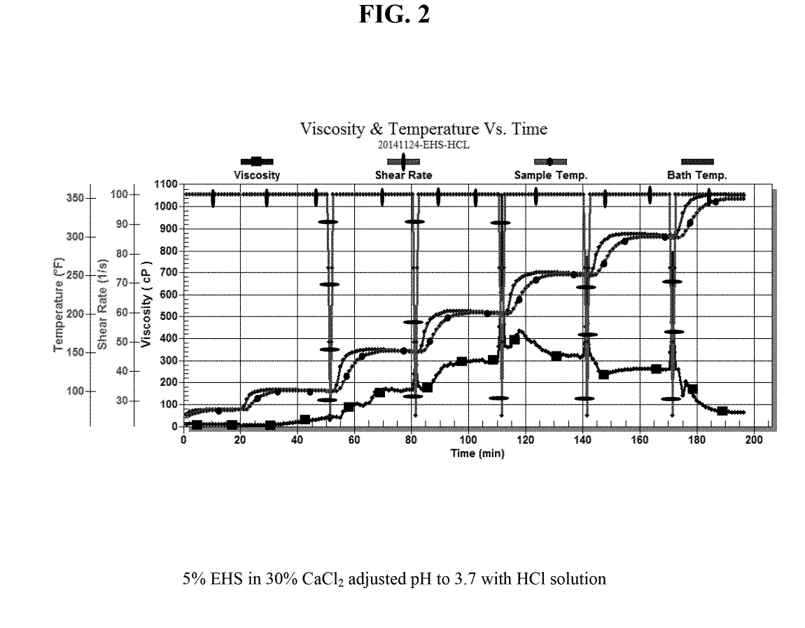

An experiment was designed to adjust pH of the 30% CaCl₂ solution to 3-4 with HCl solution. 5% EHS gave similar viscosity as the one without pH adjustment (see FIG. 2). This result showed that pH was not the major reason for the viscosity decrease.

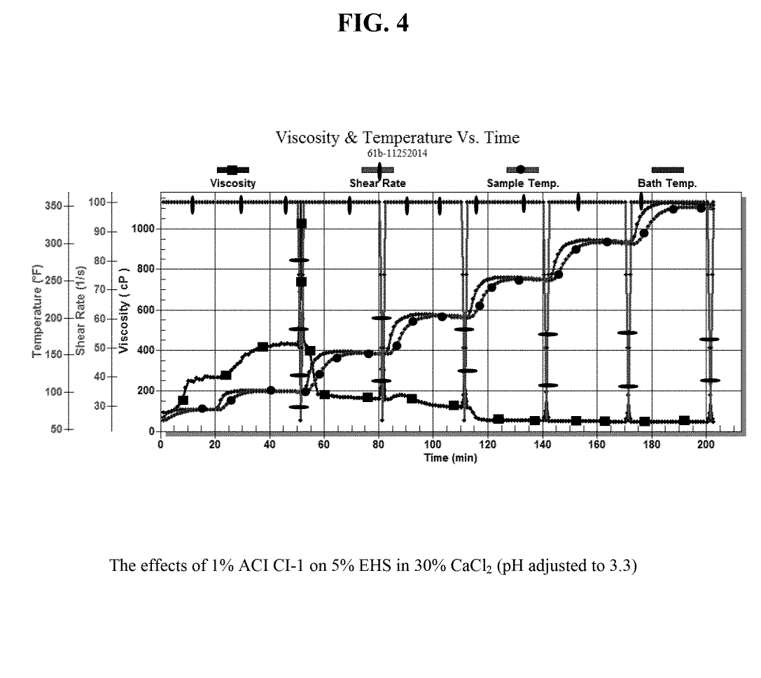

The proper way to adjust pH to 3-4 is after the addition of CI-1. FIG. 4 shows that ACI CI-1 did decrease the viscosity significantly, but some viscosity still remains even up to 350° F. However, 1% of ACI CI-1 is not enough for high temperature corrosion protection at 250° F. or above. If 2% of ACI CI-1 is added, the VES fluids lose viscosity completely.

The aforementioned experimental results showed that all these mutual solvents, organic acids or non-ionic surfactants have negative effects on the viscoelasticity of VES fluids, which makes it virtually impossible to use these VESs at 250° F. or above.

Experimental Testing for the Presently Disclosed Subject Matter

An experiment was designed to disperse ACI polymer in VES solution, whereby the VES would play the dual role of dispersing ACI and providing viscoelasticity. ACI polymer was prepared separately without any mutual solvents, organic acids, non-ionic surfactants or other dispersants. The resulting ACI polymer was then mixed with Armovis® EHS. Armovis® EHS did improve the dispersibility of the ACI polymer. However, there are two problems with this procedure. First, it is not appropriate to prepare ACI polymer without any mutual solvents, organic acids, non-ionic surfactants or other dispersants because of the high viscosity. Second, pure ACI polymer is not 100% soluble or dispersible in VES acid solution.

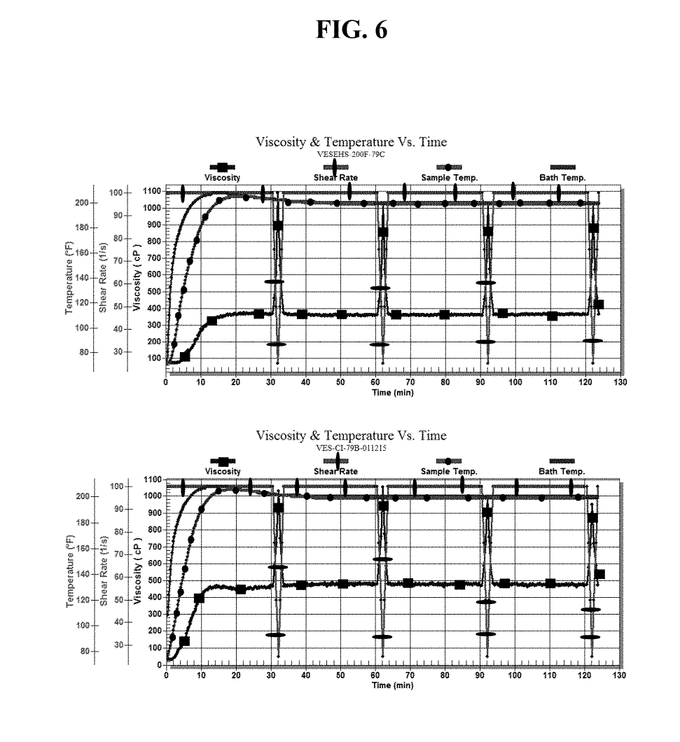

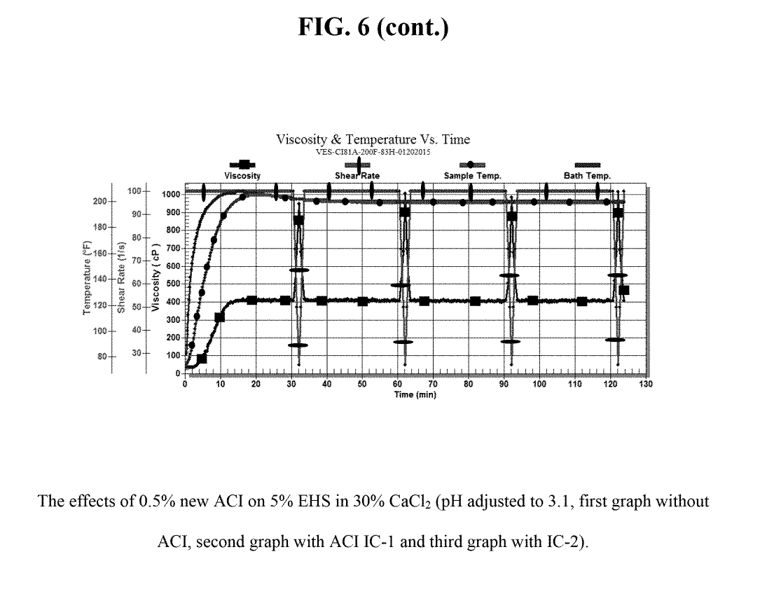

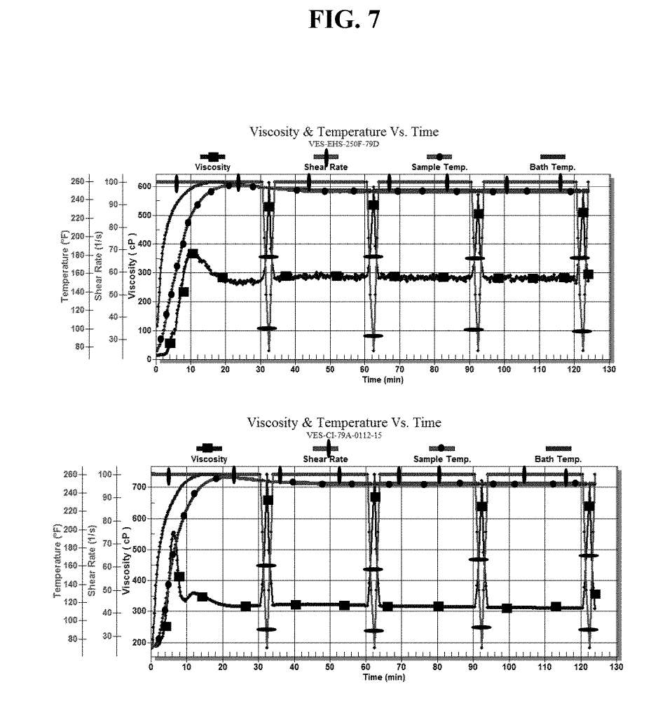

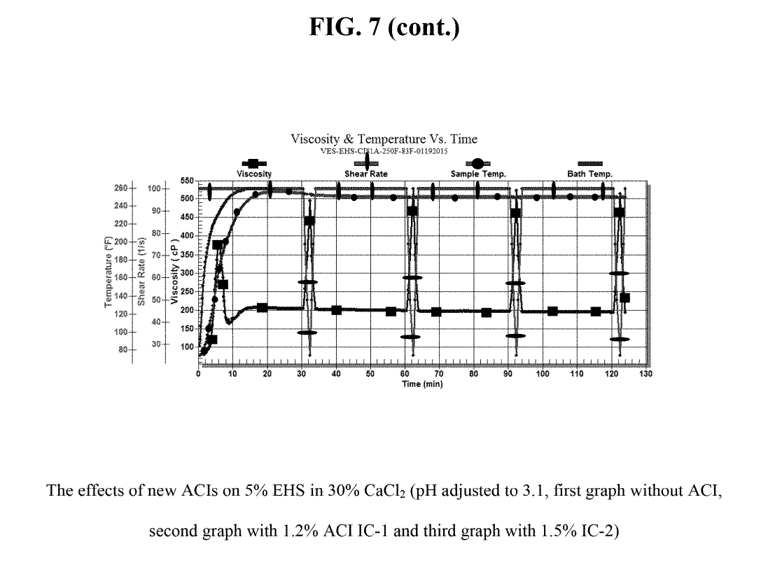

These problems were solved by polymerization of the ACI in the VES solution. The resulting product had better dispersibility in acids. It is believed that grafting of VES on the ACI polymer enhanced the compatibility of the VES and ACI polymer. Two different acid corrosion inhibitors, inventive compositions IC-1 and IC-2, were formulated from this resulting product. These ACIs can meet the requirements of acid corrosion inhibition and high viscoelasticity at 250° F. or above (see FIG. 6 and FIG. 7).

Formulations for the various acid corrosion inhibitors are provided in Table 1 below:

TABLE 1

| Material | CI-1 | IC-1 | IC-2 |
|---|---|---|---|
| Reaction product of thiourea, | 21.05% | 33.045% | 18.503% |
| paraformaldehyde and acetophenone | | | |
| EA-1 (fatty acid) | 32.103% | — | — |
| EHS-VES (Armovis ® EHS) | — | 33.705% | 18.875% |
| 31% hydrochloric acid | 2.985% | 4.679% | 2.622% |
| Acetic acid | 38.864% | 28.571% | |
| Formic acid, 95% | — | — | 60.000% |
| Water | 4.998% | — | — |

The active component for the acid corrosion inhibitor is the reaction product of thiourea, paraformaldehyde and acetophenone. An emulsifying agent (EA-1) is the dispersant used to dissolve the active component into the medium in CI-1. EHS-VES is used in IC-1 and IC-2 to replace EA-1 to dissolve the active component into the medium.

In general, several self-diverting acidizing (SDA) VES fluids were designed and generated to meet desired corrosion inhibition requirements at different temperatures and HCl concentrations. The rheology properties of these fluids were tested with an HTHP Grace M5600 rheometer at up to 300° F. EHS-VES (EHS-VES) was used as the high temperature VES and the newly-developed IC-2 was used as the corrosion inhibitor (CI). CI-3 was used as a corrosion intensifier (CI). CI-3 is a mixture of copper salts. Other additives including 50 pptg iron reducing agent (IRA-1) and 0.5% hydrogen sulfide scavenger (SS-1, also a mixture of copper salts) were also used. SS-1

Test results are provided in Table 2 below:

TABLE 2

| | 100 ml | Extra | CI | | | IRA- | | CI |
|---|---|---|---|---|---|---|---|---|
| | HCL, | CaCl₂, | IC- | CI-3, | EHS- | 1, | SS-1, | Testing |
| System | spent, | g | 2% | pptg | VES | pptg | % | Temp. |
| A | 15% | 0 | 0.6 | 30 | 6% | 50 | 0.5 | 190° F. |
| B | 28% | 0 | 0.6 | 30 | 6% | 50 | 0.5 | 190° F. |
| C | 15% | 0 | 0.6 | 100 | 6% | 50 | 0.5 | 275° F. |
| D | 28% | 0 | 0.6 | 200 | 6% | 50 | 0.5 | 275° F. |
| E | 15% | 26.4 | 0.6 | 100 | 6% | 50 | 0.5 | 275° F. |
| F | 15% | 34.0 | 0.6 | 30 | 6% | 50 | 0.5 | 190° F. |

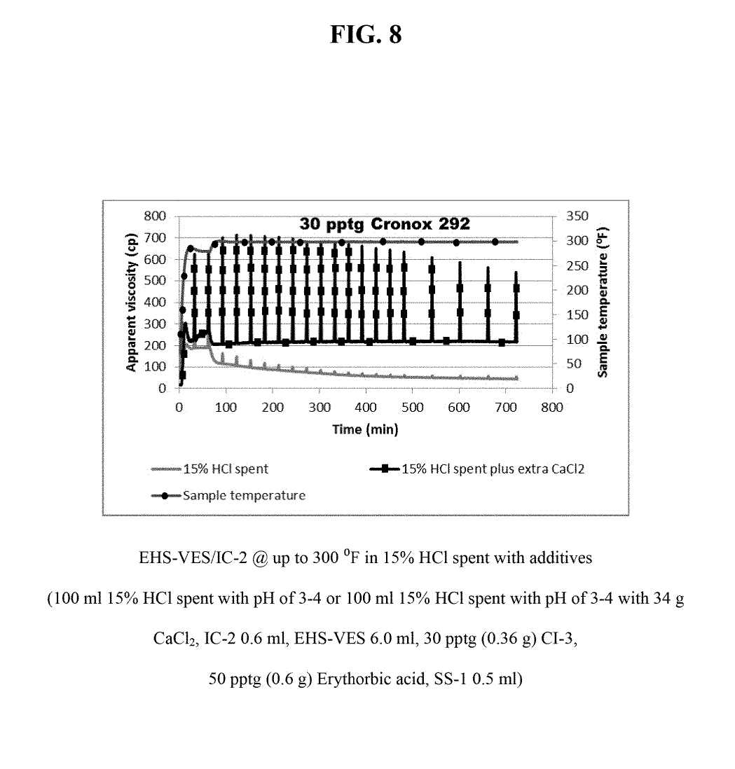

FIG. 8 shows a comparison of System A and System F (designed for 190° F. corrosion inhibition in 15% HCl). System A has apparent viscosities above 100 cp @100 s⁻¹ at up to 300° F., but its viscosity decreases gradually with time. System F has better high temperature stability when extra CaCl₂ was added into 15% HCl. Therefore, extra CaCl₂ is needed to increase the fluid viscosity at high temperatures when 15% HCl is applied in the system.

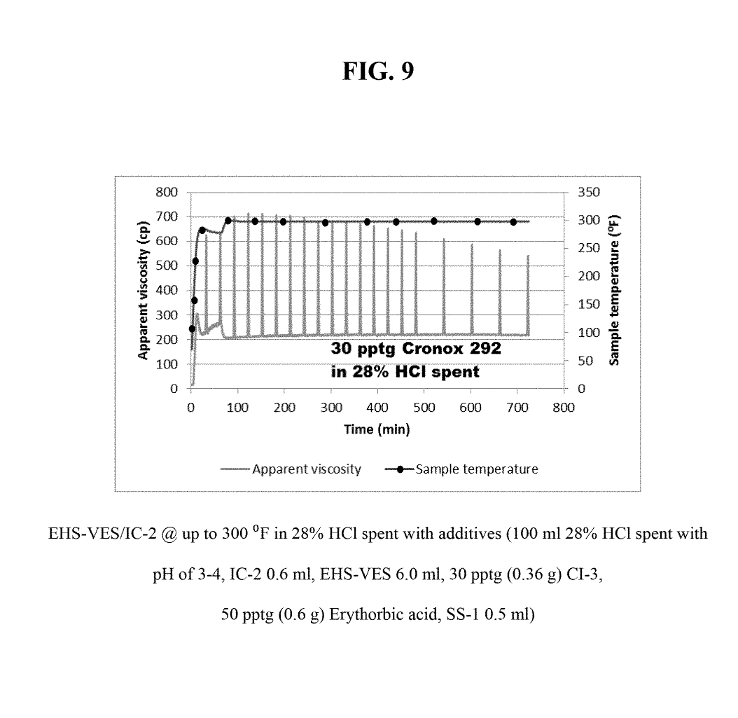

FIG. 9 shows System B (designed for 190° F. corrosion inhibition in 28% HCl). System B has apparent viscosity above 200 cp @100 s⁻¹ for up to 300° F., and its viscosity remains stable for more than 12 hours. Therefore, when 28% HCl is applied in the system, extra CaCl₂ is not needed to maintain the fluid viscosity at high temperatures.

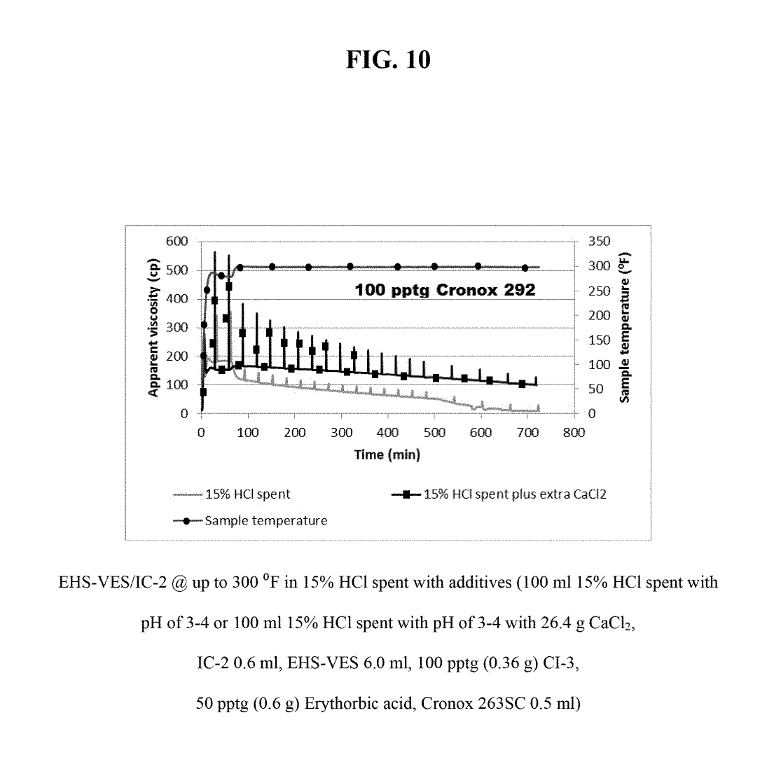

FIG. 10 shows a comparison of System C and System E (designed for 275° F. corrosion inhibition in 15% HCl). System C has apparent viscosities above 100 cp @100 s⁻¹ at up to 300° F., but its viscosity decreases gradually with time. System E has better high temperature stability when extra CaCl₂ was added into 15% HCl. Therefore, when 15% HCl is applied in the system, extra CaCl₂ is needed to increase the fluid viscosity at high temperatures.

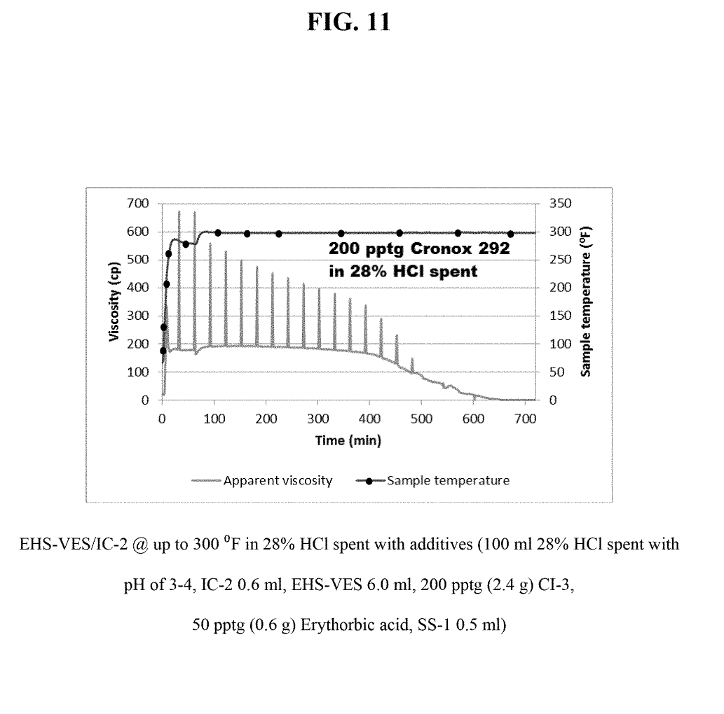

FIG. 11 shows System D (designed for 275° F. corrosion inhibition in 28% HCl). System D has apparent viscosities around 200 cp @100 s⁻¹ at up to 300° F., and its viscosity remains stable for more than 8 hours and then breaks quickly without any extra breakers. System D might be an ideal SDA system for maintaining high viscosities at up to 300° F. and breaking the fluids after a certain time without any external fluid breaker.

Table 3 below lists corrosion rates and pitting indices for EHS-VES fluids with corrosion inhibitor IC-2 in live acids. All systems from System A to System D passed the corrosion inhibition tests with corrosion rates less than 0.050 lbs/ft² and a pitting index of 0.

TABLE 3

| Testing | Acid, | | Time, | Corrosion | ACI Intensifier | | Corrosion | Pitting |
|---|---|---|---|---|---|---|---|---|
| T, ° F. | 100 ml | Metal | hrs | Inhibitor | CI-3, pptg | VES | rate, lbs/ft² | Index |
| 190 | 15% HCl | N80 | 6 | 0.6% | 30 | 6% | 0.002 | 0 |
| | | | | IC-2 | | EHS-VES | | |
| 190 | 28% HCl | N80 | 6 | 0.6% | 30 | 6% | 0.013 | 0 |
| | | | | IC-2 | | EHS-VES | | |
| 275 | 15% HCl | N80 | 6 | 0.6% | 100 | 6% | 0.005 | 0 |
| | | | | IC-2 | | EHS-VES | | |
| 275 | 28% HCl | N80 | 6 | 0.6% | 200 | 6% | 0.027 | 0 |
| | | | | IC-2 | | EHS-VES | | |
| 190 | 15% HCl | L80 | 6 | 0.6% | 30 | 5% | 0.002 | 0 |
| | | | | IC-2 | | EHS-VES | | |
| 190 | 15% HCl | L80 | 6 | 0.6% | 30 | 6% | 0.002 | 0 |
| | | | | IC-2 | | EHS-VES | | |
| 190 | 28% HCl | L80 | 6 | 0.6% | 30 | 5% | 0.012 | 0 |
| | | | | IC-2 | | EHS-VES | | |
| 190 | 28% HCl | L80 | 6 | 0.6% | 30 | 6% EHS- | 0.013 | 0 |
| | | | | IC-2 | | VES | | |
| 275 | 15% HCl | L80 | 6 | 0.6% | 100 | 5% EHS- | 0.010 | 0 |
| | | | | IC-2 | | VES | | |
| 275 | 15% HCl | L80 | 6 | 0.6% | 100 | 6% | 0.013 | 0 |
| | | | | IC-2 | | EHS-VES | | |
| 275 | 28% HCl | L80 | 6 | 0.6% | 200 | 5% | 0.032 | 0 |
| | | | | IC-2 | | EHS-VES | | |
| 275 | 28% HCl | L80 | 6 | 0.6% | 200 | 6% | 0.036 | 0 |
| | | | | IC-2 | | EHS-VES | | |
| 190 | 15% HCl + | L80 | 6 | 0.6% | 30 | 6% | 0.008 | 0 |
| | CaCl₂ | | | IC-2 | | EHS-VES | | |
| | (System E) | | | | | | | |
| 275 | 15% HCl + | L80 | 6 | 0.6% | 30 | 6% | 0.038 | 0 |
| | CaCl₂ | | | IC-2 | | EHS-VES | | |
| | (System F) | | | | | | | |

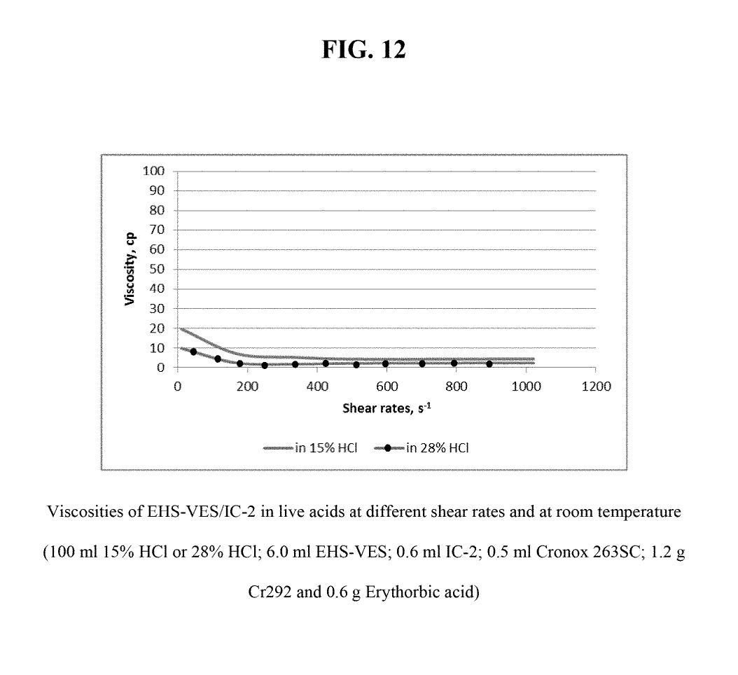

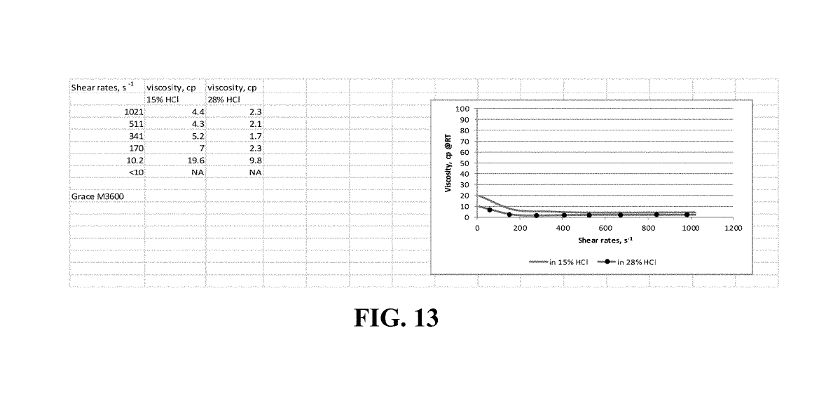

FIGS. 12 and 13 show the viscosity of live acids at ambient temperature. All systems from System A to System D in live acids have very low viscosities at ambient temperature which means there are no pumping issues for these fluids.

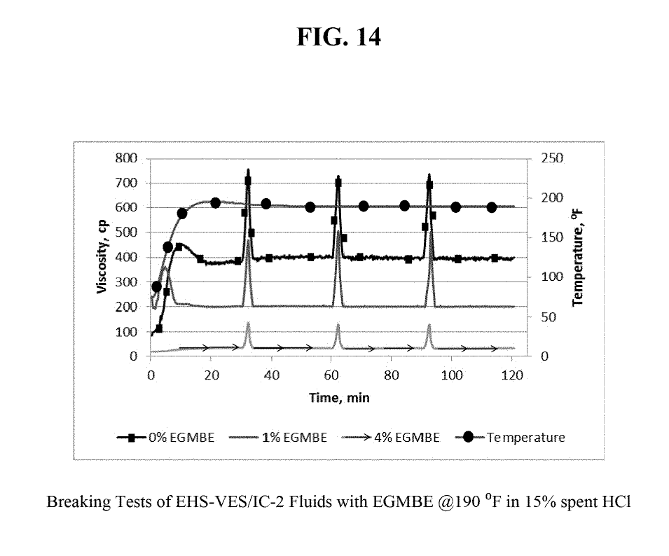

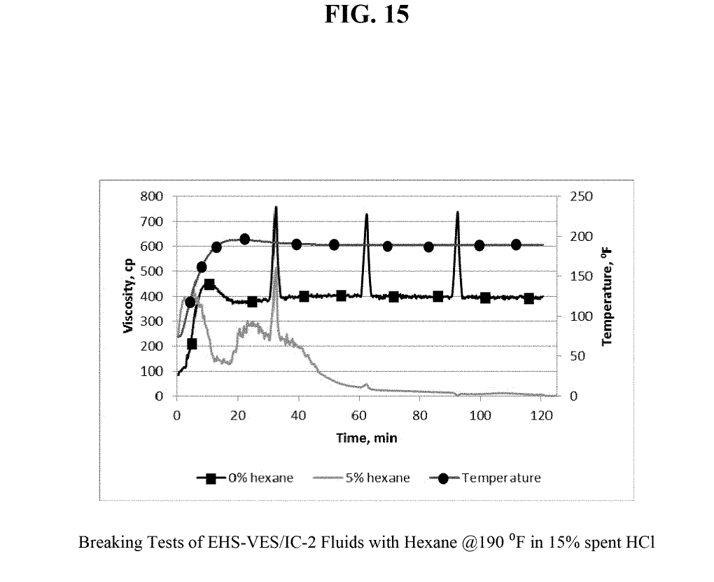

System D could break by itself with time at high temperatures. Thus, it is a self-breaking SDA VES fluid. Some systems are more stable at some specific conditions, such that external breakers might be needed. Two external breaking systems were tested. One method is to apply post-flushing fluids. Ethylene glycol monobutyl ether (“EGMBE”) is used as the mutual solvent. FIG. 14 shows that the addition of EGMBE is effective to break the viscosity of VES fluids. Another breaking method is to contact hydrocarbon solvent during fracturing. Hexane was tested as the hydrocarbon solvent. FIG. 15 shows that the addition of hexane is effective to break the viscosity of VES fluids.

The presently disclosed subject matter has a number of advantages over prior art systems. For example, in prior systems the thermal limits of the viscosifying properties for the depleted acid were about 120° C./250° F., whereas in the presently disclosed system, thermal limits are up to 350° F. or above. Also, prior systems exhibited a reduction of viscosification upon addition of necessary corrosion inhibitors into the field applied solution. The presently disclosed system does not display any such reduction of viscosification. Prior systems underwent a loss of elastic properties (which enhance diversion) for the depleted fluid at low temperatures of about 100° C./210° F. The presently disclosed system does not display any such loss. Prior systems were intolerant to Iron (III) picked up from dissolution of corrosion products, which lead to phase separation and potential damage upon injection into the reservoir, whereas the presently disclosed system is tolerant to Iron (III). Prior systems required a high concentration of VES (about 5-8%) in acid to develop diversion, making the solutions expensive. The presently disclosed system only requires low amounts of VES (about 3%) to develop diversion. Finally, the viscoelastic surfactants of prior systems displayed high toxicity, thus eliminating these products from consideration in some parts of the world and causing a significant environmental burden when fluids were disposed in marine environments. The presently disclosed system is non-toxic. In general, a polymer-free, low molecular weight viscoelastic surfactant based fracturing fluid system is provided that has performance properties similar to crosslinked polymer fluid systems but with superior formation and proppant pack cleanup.

While the disclosed subject matter has been described in detail in connection with a number of embodiments, it is not limited to such disclosed embodiments. Rather, the disclosed subject matter can be modified to incorporate any number of variations, alterations, substitutions or equivalent arrangements not heretofore described, but which are commensurate with the scope of the disclosed subject matter.

Additionally, while various embodiments of the disclosed subject matter have been described, it is to be understood that aspects of the disclosed subject matter may include only some of the described embodiments. Accordingly, the disclosed subject matter is not to be seen as limited by the foregoing description, but is only limited by the scope of the appended claims.

What is claimed is:

1. An acid corrosion inhibitor for use with a viscoelastic surfactant fluid, the acid corrosion inhibitor comprising: an active inhibition compound; and a viscoelastic surfactant.

2. The acid corrosion inhibitor of claim 1, wherein the active inhibition compound comprises a reaction product of thiourea, formaldehyde, acetophenone, or amines, amine quaternaries, or mixtures thereof.

3. The acid corrosion inhibitor of claim 1, wherein the viscoelastic surfactant comprises a betaine-based surfactant.

4. The acid corrosion inhibitor of claim 3, wherein the betaine-based surfactant comprises erucamidopropyl hydroxypropylsultaine.

5. The acid corrosion inhibitor of claim 1, wherein the viscoelastic surfactant comprises an amine oxide-based surfactant.

6. The acid corrosion inhibitor of claim 1, wherein the viscoelastic surfactant comprises a cationic surfactant.

7. The acid corrosion inhibitor of claim 1, wherein the active inhibition compound comprises an inhibition compound that is effective in acidizing fluids.

8. The acid corrosion inhibitor of claim 1, further comprising an organic acid.

9. The acid corrosion inhibitor of claim 8, wherein the organic acid comprises acetic acid.

10. The acid corrosion inhibitor of claim 8, wherein the organic acid comprises formic acid.

11. A viscoelastic surfactant fluid for enhancing the productivity of a hydrocarbon bearing subterranean formation, the viscoelastic surfactant fluid comprising an acid corrosion inhibitor comprising an active inhibition compound and a compatible viscoelastic surfactant.

12. The viscoelastic surfactant fluid of claim 11, wherein the acid corrosion inhibitor further comprises an organic acid.

13. The viscoelastic surfactant fluid of claim 11, wherein the viscoelastic surfactant comprises a betaine-based surfactant.

14. The viscoelastic surfactant fluid of claim 11, wherein the viscoelastic surfactant comprises erucamidopropyl hydroxypropylsultaine.

15. The viscoelastic surfactant fluid of claim 11, wherein the viscoelastic surfactant comprises an amine oxide-based surfactant.

16. The viscoelastic surfactant fluid of claim 11, wherein the viscoelastic surfactant comprises a cationic surfactant.

17. The viscoelastic surfactant fluid of claim 11, wherein the active inhibition compound comprises a reaction product of thiourea, formaldehyde, acetophenone, or amines, amine quaternaries, or combinations thereof.

18. The viscoelastic surfactant fluid of claim 11, wherein the active inhibition compound comprises an inhibition compound that is effective in acidizing fluids.

19. A method of treating a hydrocarbon bearing subterranean formation, the method comprising:
introducing a treatment fluid into the subterranean formation, the treatment fluid comprising a viscoelastic surfactant fluid and an acid corrosion inhibitor that is compatible with the viscoelastic surfactant fluid, the acid corrosion inhibitor comprising an acid, an erucamidopropyl hydroxypropylsultaine, and a reaction product of thiourea, formaldehyde and acetophenone; and
treating the subterranean formation with the treatment fluid.

20. The method of claim 19, wherein the hydrocarbon bearing subterranean formation is subjected to fracturing during treatment with the treatment fluid.

21. The method of claim 19, wherein the hydrocarbon bearing subterranean formation is subjected to acidizing during treatment with the treatment fluid.
